(19) United States
(12) Patent Application Publication
(10) Pub. No.: US 2002/0180866 A1
(43) Pub. Date: Dec. 5, 2002

(54) Modular sensor array

(76) Inventor: David A. Monroe, San Antonio, TX (US)

Correspondence Address: Attn: Robert C. Curfiss, BRACEWELL & PATTERSON, L.L.P., P.O. Box 61389, Houston, TX, 77208-1389, US

(21) Appl. No.: 09/866,984

(22) Filed: May 29, 2001

(51) Int. Cl. H04N 7/18

(52) U.S. Cl. 348/153; 348/143; 348/164; 250/330; 250/332; 250/353

(57) ABSTRACT

A compact, modular, comprehensive, multimedia, surveillance system provides multiple data capture and management capability for field personnel. The system includes a modular sensor array having a standard base module or platform upon which a myriad of systems may be mounted for providing a wide range of flexibility and functionality. A remote base station can be incorporated having a remote, possibly laptop, computer with appropriate Government communications card and an image frame capture card, a printer, and a power inverter to operate the system on 24 VDC military power. The control module is adapted for transmitting all captured data to the base station via a wireless communications link or via plug-in cabling for archiving and managing the data. Modules include a high performance night vision system, a high performance day vision system; an uncooled FLIR; cooled FLIR; RF probe; NBC detector; sensor computer modules; a laser range finder unit, a MELIOS unit and the like. The system has full modularity and various components can be connected as desired, with virtually no limitation in the functionality.

### BACKGROUND OF INVENTION

1. Field of Invention

This invention is generally related to field surveillance equipment and is specifically directed to a multi-function, modular, portable field system having common control, power and management electronics for a plurality of distinct surveillance module units.

2. Description of the Prior Art

Military scouts and other personnel who are tasked to perform surveillance and reconnaissance operations must deal with widely varying conditions. These include different types of subject material to observe, differing environmental conditions such as lighting, humidity, temperature, dust and pollution, all which may adversely impact surveillance, and threat conditions such as terrain, water, chemical hazards, radiation hazards, or hostile military or civilian attacks.

A variety of sensors are currently being utilized by scouts in order to accommodate the conditions and situations that they encounter. Daylight Cameras, Image Intensifiers, uncooled FLIR (Forward Looking Infrared) systems, Laser Rangefinders, RF Sensors, GPS receivers, NBC Detectors (Nuclear, Biological, Chemical Detectors), and other types of sensors are currently being utilized for surveillance and reconnaissance operations. It is also desired to utilize cryogenic FLIR systems, which are currently too cumbersome and noisy to man-carry.

Surveillance personnel may have to walk great distances to get in an ideal position to perform surveillance. The weight of the system required becomes an important factor to the scout. Also the number of different types of devices that may be required to perform the spectrum of surveillance required can increase the scout's load and the complexity of the task, requiring the operator to understand the details of operation of a diverse assemblage of disjointed units. Further, powering a fleet of diverse units all independently designed requires a variety of different types of batteries, thus generating more cost, weight and confusion.

Military scouts and other personnel who are tasked to perform surveillance and reconnaissance operations must deal with widely varying conditions. These include different types of subject material to observe, differing environmental conditions such as lighting, humidity, temperature, dust and pollution all which may adversely impact surveillance, and threat conditions such as terrain, water, chemical hazards, radiations hazards, or hostile military or civilian attacks.

Finally, the output of the sensors has traditionally been viewed by a human. It is becoming increasingly obvious that the data from the sensors has more value if it can be digitized, recorded, exploited through enhancement and analysis, and transmitted to other locations. Currently this is being attempted primarily by cumbersome retrofit attachments that do not perform in an optimum manner such as clip on cameras and communications controllers external to the sensors.

Examples of currently available surveillance devices are: Binoculars/Telescopes (e.g., Steiner 7×50 G , 37 oz, 368 ft FOV at 1000 yards, 17 mm eye relief, Canon 15×45 IS Image Stabilized Binoculars, 36 oz, 67 degree FOV, 15 mm eye relief, and other models); Image Intensifier Devices (e.g., AN/PVS-10 Sniper Day/Night Sight (SNS) integrated day/night sight for the M24 Sniper Rifle which provides the sniper with the capability to acquire and engage targets under both day and night conditions. For nighttime operation, the system utilizes third generation image intensification technology); Passive, Third Generation Image Intensification (18 mm Image Intensifier Tube); AN/PVS-14 Monocular Night Vision Device and Night Sight (The AN/PVS-4A is a night sight for an Individual served weapon which provides the soldier with the capability to acquire and engage targets under night conditions. The system utilizes third generation image intensification technology); Passive, Third Generation Image Intensification 25 mm Image Intensifier Tube; AN/PVS-7D Night Sight (Provides leaders of combat infantry units with a light weight, Gen III night vision device for use in observation and command and control, and also can be mounted to small arms rail using a rail grabber); Passive third generation image intensification (18 mm image intensifier tube, accepts all ancillary items of the AN/PVS-7D Night Vision Goggles); Uncooled FLIRs (e.g., AN/PAS-13 TWS (Thermal Weapons Sight) manufactured by Raytheon, AN/PAS-20); Cooled FLIRs (e.g., HIT Second Generation FLIR manufactured by Raytheon); RF Imager; RF Probe; Laser Rangefinder (e.g., AN/PVS-6 manufactured by Varo or LLDR—Lightweight Laser Designator Rangefinder); NBC Detectors (e.g., Chemical Agent Detector by Graseby's Chemical Agent Monitor—a hand held instrument to monitor nerve and blister agents and can be reprogrammed to meet further threats); BRUKER IMS 2000 (uses the principle of ion mobility to differentiate between various agent vapors. Ambient air bearing water vapor in the form of natural humidity is drawn into the unit. And is ionized by a low energy beta source. Different tracer gases enable detection of a range of gases as they pass through the membrane and react with ions); Radiation Detection (e.g., Radiac Set AN/VDR-2 for performing ground radiological surveys in vehicles or in the dismounted mode by individual soldiers as a hand-held instrument. The set can also provide a quantitative measure of radiation to decontaminate personnel, equipment, and supplies. Components of the Radiac Set include the Radiacmeter IM-243, Probe DT-616, and pouch with strap. Installation kits are available as common table allowances (CTA) items for installation of the Radiac Set in various military vehicles. The set includes an audible and/or visual alarm that is compatible with vehicular nuclear, biological and chemical protective systems in armored vehicles and also interfaces with vehicular power systems and intercoms); Sensor Support Devices; Clip on Video Cameras; Still Video Cameras; Camcorders; GPS Receivers; Image Transmission Systems; PhotoTelesis MMR; Field Computers; Battery Packs; Tripods.

The burdensome task of carrying and managing this amount of equipment in field operations is almost impossible. If field personnel are to be fully equipped and still remain mobile and flexible, modularity, miniaturization and weight reductions are a necessity.

### SUMMARY OF INVENTION

The subject invention is directed to a compact, modular, comprehensive, multimedia, surveillance system providing multiple data capture and management capability for field personnel. The system comprises a modular sensor array having a standard base module or platform upon which a myriad of systems may be mounted for providing a wide range of flexibility and functionality.

On embodiment of the system comprises the base control module assembly, a daylight vision assembly, a night vision assembly, a laser rangefinder, and a military GPS receiver. The daylight and night vision configurations may be operated stand alone, or may be operated in conjunction with the PhotoTelesis MMR (Military Micro RIT (Remote Image Transceiver). Various Military Radios may be utilized for image and collateral data transmission. A remote base station can be incorporated having a remote, possibly laptop, computer with appropriate Government protocol and/or commercial communications card and an image frame capture card, a printer, and a power inverter to operate the system on 24 VDC military power. The control module is adapted for transmitting all captured data to the base station via a wireless communications link or via plug-in cabling for archiving and managing the data, or may be operated in conjunction with the PhotoTeleis MMR providing communications and processing functions. Additional modules include a high performance day vision system; an uncooled FLIR (Forward Looking Infrared sensor); cooled FLIR; RF probe; NBC detector; sensor computer modules; a laser rangefinder unit and the like. The system has full modularity and various components can be connected as desired, with virtually no limitation in the functionality.

The system of the subject invention greatly improves the utility and functionality of field surveillance units. This is accomplished by providing a standard “platform” upon which different types of sensors and other components may be supported. This accomplishes many things, including the reduction in total electronics through shared utilization, use of one battery type, providing a common user interface for all types of sensors, reduced field support costs and training requirements, and providing a single point of interface for data transfer of all data types to other systems using standardized formats and techniques, such as to vehicle systems, recording systems, briefing systems, intelligence systems and the like.

In the preferred embodiment of the invention the base module contains the control panel, the power source, electronics and a standardized mounting system. The various components are simply plugged into the standardized mounting system, whereby each component is properly mounted and is connected to the power, electronics and control system. The changeover from one component to another can be accomplished in a matter of a few seconds. By providing a standardized base module and compatible components a single power supply, single control electronics and single data management electronics, including imaging processing software may be used for all components, greatly reducing the weight and size of the overall surveillance system.

It is, therefore, an object and feature of the subject invention to provide a fully modular, multiple function field surveillance system.

It is another object and feature of the subject invention to provide a surveillance system having a single power supply, common control and management electronics.

It is a further object and feature of the subject invention to provide a system capable of adjusting the gain of an image intensifier in conjunction with other functions for various modules of the system.

It is also an object and feature of the subject invention to provide a system capable of permitting, in the alternative, viewing of “raw” or unprocessed video, or frame averaging, also called frame integration, that allows accurate mathematical integration of multiple frames to provide enhanced images.

Additional objects and features of the subject invention include:

1) Shared use of image processing hardware and software for noise reduction for multiple component units (particularly useful for image intensifiers and FLIRS).

2) Shared use of image processing hardware and software for contrast enhancement for multiple component units.

3) Shared use of motion detection and alarm hardware and software for multiple component units.

4) Shared use of image stabilization hardware and software for multiple component units.

5) Shared use of contrast enhancement hardware and software for multiple component units.

6) Shared use of image cropping hardware and software for multiple component units.

7) Shared use of image processing filtering functions for multiple component units.

8) Shared use of image compression hardware and software for multiple component units.

9) Shared use of communications protocols, hardware and software for multiple component units.

10) Shared use of digital storage hardware and software for multiple component units.

11) Shared use of geolocation hardware and software, such as GPS, for multiple component units.

12) Shared use of Geolocation hardware and software in conjunction with a magnetic compass, inclinometer and laser rangefinder in order to calculate geolocation of targets that are of interest.

13) Shared use of power supply hardware and control software, and common battery types for multiple component units.

14) Shared use of video processing hardware and associated software, such as the video decoder and video encoder circuits, video time base, and the like.

15) Shared use of Gain Control Elements for multiple optical imaging modules.

16) Shared use of video zoom hardware and software for multiple component units.

17) Shared use of Electronic Viewing Device for multiple component units.

18) Shared use of user interface controls for multiple component units.

19) Shared use of a handgrip for portable use of multiple component units.

20) Shared use of electronic interface for sensor data to other systems for multiple component units.

21) Shared use of mounting equipment for multiple component units, such as a tripod mount or leg kit.

22) A common mechanical and electrical method of attaching various sensors to a control module and for providing support and electrical interface.

23) A common user interface with similar commands for similar functions between multiple component units.

24) Use of an attachable daylight camera module on a common control module.

25) Use of an attachable image intensifier module on a common control module.

26) Use of an attachable uncooled FLIR module on a common control module.

27) Use of an attachable cooled FLIR module on a common control module.

28) Use of an attachable RF probe on a common control module.

29) Use of an attachable RF imaging sensor on a common control module.

30) Use of an attachable laser rangefinder on a common control module.

31) Use of an attachable chemical detection and analysis module on a common control module.

32) Use of an attachable radiation detection and analysis module on a common control module.

33) Use of a thermonic cooler to cool a focal plane array FLIR—approximate temperature 77° K.

34) Storage of sensor setting parameters in non-volatile memory in the sensor module (gain, integration, contrast, and the like).

35) Dynamic menus in control module changes with sensor that is attached.

36) Downloading of control module code or commands, or part of the code or commands from the Sensor to the control module. This provides a “universal” control module that can support sensors developed after the control module, or upgrades to sensors developed after the control module.

37) Use of an “http” browser in the control module.

38) Use or “mini-servers” to serve the user interface and application for the sensor.

39) Use of IP as an interface between the control module and the sensor.

40) Use of IP as an interface between the control module and other devices.

41) Use of a “mini-server” in the control module to serve data to workstations or other devices from the sensor to the other devices.

Other objects and features of the invention will be readily apparent from the accompanying drawings and description of the preferred embodiment.

### BRIEF DESCRIPTION OF THE DRAWINGS

FIG. 1 is an exploded view of the system including a base module, a plurality of sensor components, connectivity modules and communications modules.

FIG. 2 is similar to FIG. 1 with a military sensor computer base module.

FIG. 3 is a perspective view of the computer base module of FIG. 2, showing the mounting rail for the sensor components in greater detail.

FIG. 4 is a view similar to FIG. 3, showing the day channel module and the night channel module.

FIG. 5 is a flow chart of the system electronics in the base module.

FIG. 6 shows the elements of an image intensifier module.

FIG. 7 shows sequencing adjustment for the image intensifier module.

FIG. 8 illustrates programmable elements of the system adapted for adjustment in any desired manner for each step in gain setting.

FIG. 9 is a depiction of the operation of the hardware and state machine for the frame averager.

FIG. 10 is a block diagram of the base module assembly.

FIG. 10a is an exploded view of the base module assembly.

FIG. 10b is a partial view of the hidden portion of the exploded view of FIG. 10.

FIG. 10c is a perspective view of the assembled unit.

FIGS. 10d-10i are circuit diagrams for the base control module.

FIG. 11 is a block diagram of the night vision channel module.

FIG. 11a is an exploded view of the night vision channel module assembly.

FIGS. 11b-11d are circuit diagrams for the night vision controller.

FIG. 12 is a block diagram of the day vision channel module.

FIG. 12a is an exploded view of the day vision module assembly.

FIGS. 12b-12e are circuit diagrams for the day vision controller.

### DESCRIPTION OF THE PREFERRED EMBODIMENT

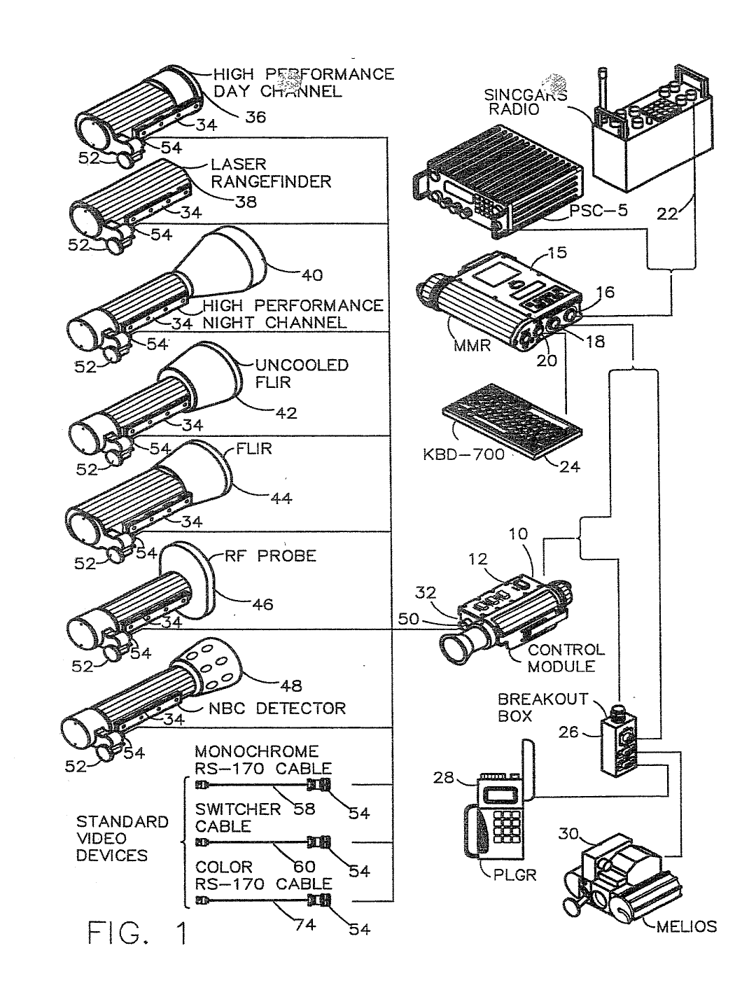

An exploded view of the modular system of the subject invention is shown in FIG. 1. The base module 10 includes the electronics (inside); controls 12 and power supply 14 for all of the components of the system. In this embodiment, the module includes a standard connector (not visible) for cabling the module a management unit such as, by way of example, the PhotoTelesis MMR 15. The MMR unit includes standard connectors 16, 18, and 20 for a communications link 22, an input device such as the keyboard 24 and a breakout box 26, respectively. The communications device in the preferred embodiment is a PSC-5 with a Sincgars radio. It should be understood that other communications links such as cellular telephone, secure telephone, satellite transmission, an Internet gateway or other could be substituted without departing from the scope and spirit of the invention. The input device is shown as a ruggedized keyboard. Other input devices can be readily substituted. The breakout device 26 is adapted for further increasing the flexibility of the system by permitting the attachment of additional modules such as, by way of example the PLGR unit 28 and MELIOS unit 30.

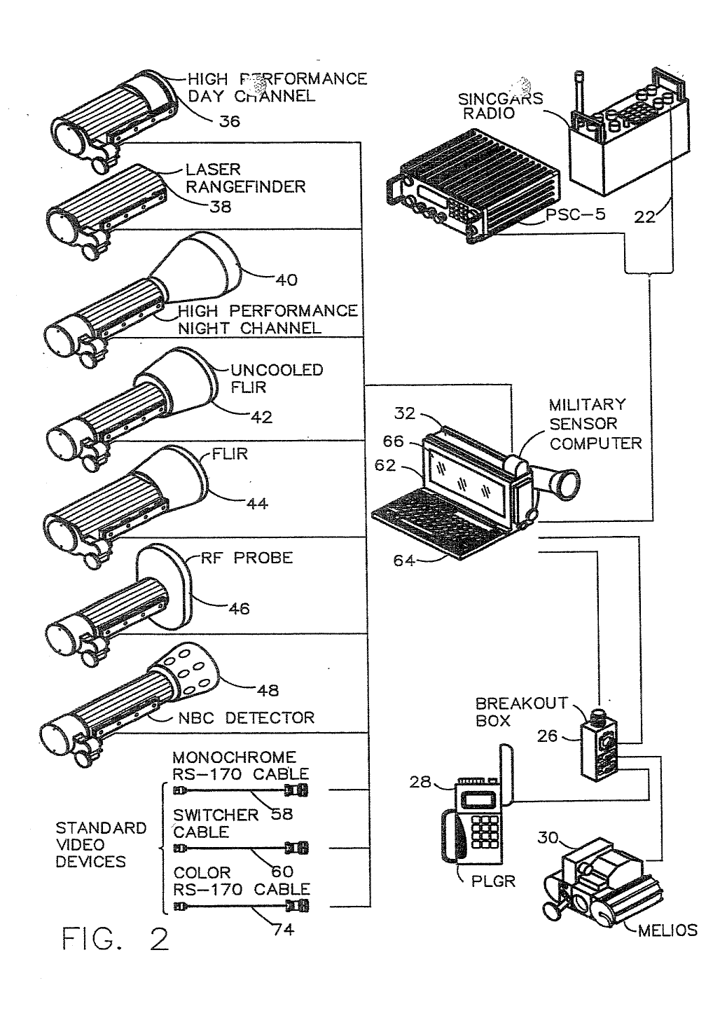

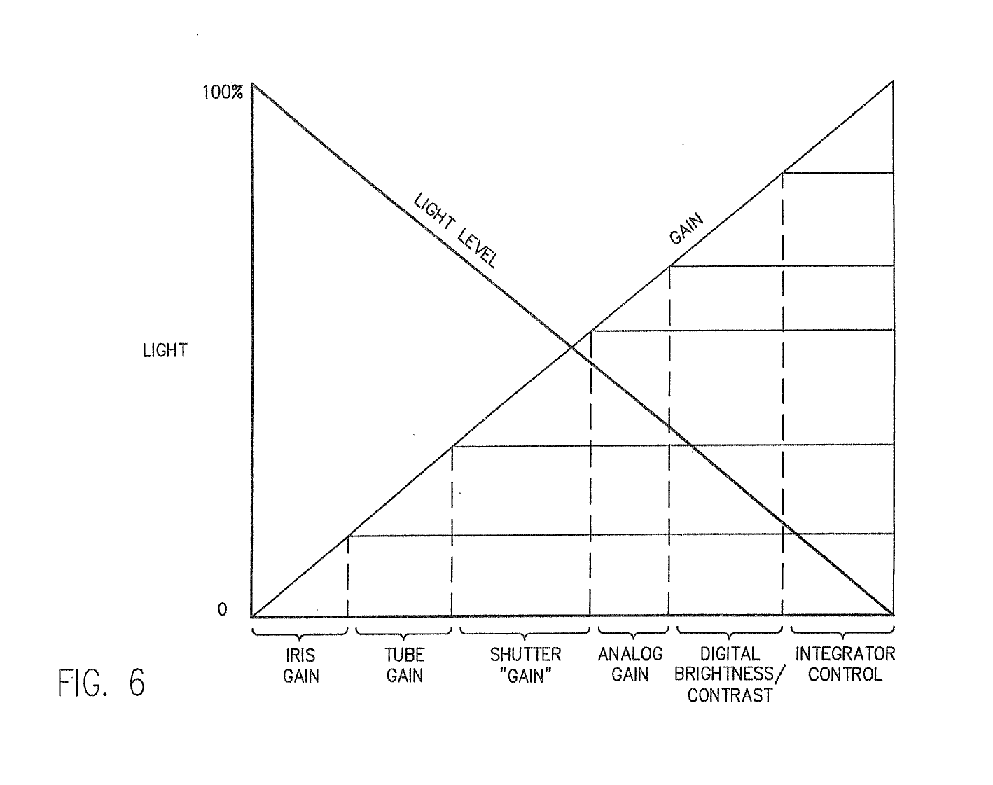

The base module 10 includes a mounting rail system 32, as better seen in FIGS. 2 and 6. The mounting rail system defines a channel or slide for receiving the compatible connector rail 34 provided on each of the various sensor units, as here shown including the high performance day module 36, the laser range finder 38, the high performance night module 40, the uncooled FLIR module 42, the FLIR module 44, the RF probe module 46, and the NBC detector 48.

The base module and each of the component modules also include a mechanical locking system for locking the installed module on the base. In the illustrated embodiment, the base includes a threaded hole 50 and each of the components include a mated locking screw 52 for securing mounted component to the base once the rail 34 is received in the slide channel 32.

A common connector plug assembly 54 is provided on each of the component modules and is received in a mated receptacle 56 on the base 10 as the component is received in the slide and locked in mounted position. This connects the module with the power supply, controls and system electronics. The receptacle 56 may also be used for connecting various connector cables to standard video or other devices, such as the monochrome RS-170 cable 58, the switcher cable 60 and the color RS-170 cable 74, each of which is provided with the compatible plug 54.

The system shown in FIG. 2 is similar to that shown in FIG. 1, the base module 10 and the MMR module 15 and keyboard 22 having been replaced by a handheld military sensor computer 62 having a hinged keyboard input device 64 and a display panel or screen 66. The communications link 22 is attached directly to the computer by cabling, as previously described. The various components are mounted on the slide 32, as before, with the locking system and connector plug assembly provided on the computer base in the same manner as the base unit of FIG. 1.

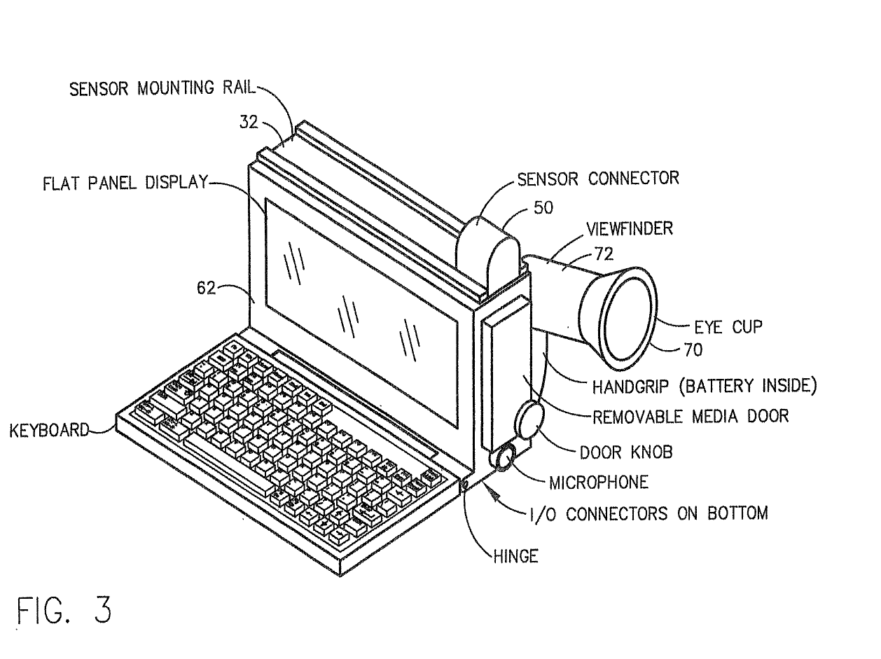

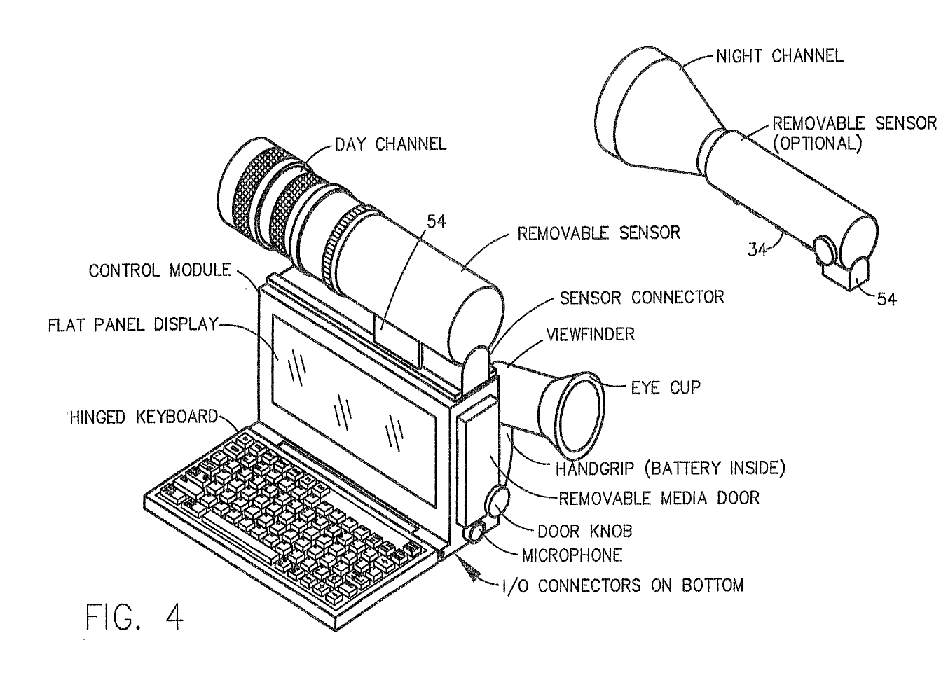

The computer base is shown in greater detail in FIGS. 3 and 4. With specific reference to FIG. 3, the component mounting slide channel 32 is mounted on the top side of the computer base unit 62. The connector receptacle 50 in this embodiment is located in the rearward end of the slide channel for receiving the compatible plug 54 in the various modules, see FIG. 4. The locking assembly is also located in this position. The eyepiece or eyecup 70 and the viewfinder 72 extend conveniently rearward of the unit. As best seen in FIG. 4, a component rail system 34 is axially positioned for sliding in the channel 32 until the component plug 54 mates with the base receptacle 52, after which the locking system is tightened for locking the component in functional assembly with the base. The same system is utilized in the configuration of FIG. 1.

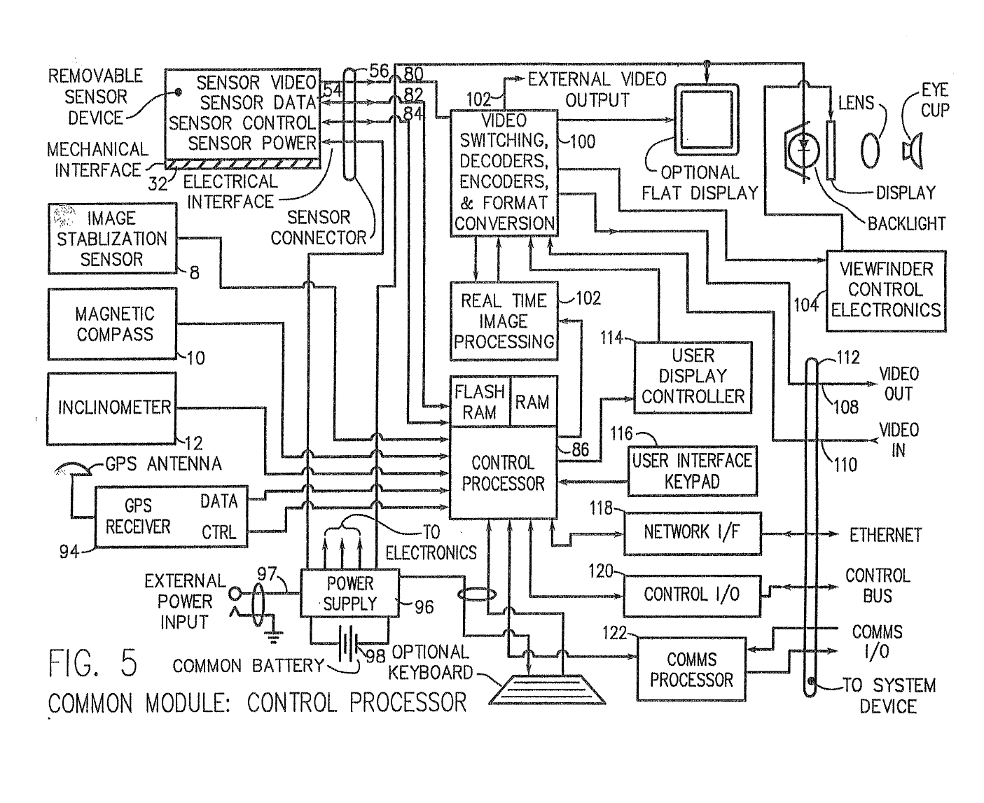

FIG. 5 is an overall system control diagram for the modular system of the subject invention. Each sensor module is adapted to be mechanically secured to the base via the previously described rail and slide system 32, 34, as indicated. When this is completed, the receptacle and plug system 52, 54 completes the electrical interface connection, permitting output signals to be transmitted from the module to the base via line 80, control signals to be transmitted from the base to the module via line 82 and power to be supplied via power line 84. The control processor is a low power embedded processor 86. The preferred embodiment of the invention includes an image stabilization sensor 88, a magnetic compass 90 an inclinometer 92 and a GPS receiver 94 all housed within the base unit and connected to the control processor 86 for assisting in the collection of useful data by stabilizing, aiming, positioning and managing the collected data. A common power supply 96 is provided and may use external power input via cabling 97 or an integral battery source 98. The various inputs to the processor 86 include the sensor input as well as the various managing inputs from devices 88, 90, 92 and 94.

The sensor input 80 is first introduced into a video switching and format conversion circuit 100 for both encoding and decoding the raw data. This circuit is in communication with a real time image processing circuit 102 which is controlled and managed by the central processor 86 for providing output via the circuit 100 to the viewfinder network 104, external video output signals as indicated at 106, and communication links with various video devices as indicated on lines 108 and 110 at interface 112. The control processor 86 also controls the user display controller 114 and is in communication with the user input device 116 (such as the keyboard 24 shown in FIG. 1). Network interfacing circuit 118 provides communication over networks via the interface 112. Likewise, an input/output control module 120 provides external control via the interface 112 and communication links are provided through the interface 112 via the communications processor, all controlled by the central processor 86.

The communications processor and software of the control system is adapted to include the following functions:

1) Shared use of Image Processing hardware and software for noise reduction for multiple component units (particularly useful for Image Intensifiers and FLIRS).

2) Shared use of Image Processing hardware and software for contrast enhancement for multiple component units.

3) Shared use of Motion Detection and Alarm hardware and software for multiple component units.

4) Shared use of Image Stabilization hardware and software for multiple component units.

5) Shared use of Contrast Enhancement hardware and software for multiple component units.

6) Shared use of Image Cropping hardware and software for multiple component units.

7) Shared use of Image Processing Filtering Functions for multiple component units.

8) Shared use of Image Compression hardware and software for multiple component units.

9) Shared use of Communications Protocols, hardware and software for multiple component units.

10) Shared use of Digital Storage hardware and software for multiple component units.

11) Shared use of Geolocation hardware and software, such as GPS, for multiple component units.

12) Shared use of Geolocation hardware and software in conjunction with a magnetic compass, inclinometer and laser rangefinder in order to calculate geolocation of targets that are of interest.

13) Shared use of Power Supply hardware and control software, and common battery types for multiple component units.

14) Shared use of Video Processing hardware and associated software, such as the video decoder and video encoder circuits, video time base, and the like.

15) Shared use of Gain Control Elements for multiple optical imaging modules.

16) Shared use of Video Zoom hardware and software for multiple component units.

17) Shared use of Electronic Viewing Device for multiple component units.

18) Shared use of User Interface Controls for multiple component units.

19) Shared use of a Handgrip for Portable Use of multiple component units.

20) Shared use of Electronic Interface for sensor data to other systems for multiple component units.

21) Shared use of Mounting Equipment for multiple component units, such as a tripod mount or leg kit.

22) Common Mechanical and Electrical Method of attaching various sensors to a control module and for providing support and electrical interface.

23) A Common User Interface with similar commands for similar functions between multiple component units.

24) Use of an attachable Daylight Camera Module on a common Control Module.

25) Use of an attachable Image Intensifier Module on a common Control Module.

26) Use of an attachable Uncooled FLIR Module on a common Control Module.

27) Use of an attachable Cooled FLIR Module on a common Control Module.

28) Use of an attachable RF Probe on a common Control Module.

29) Use of an attachable RF Imaging Sensor on a common Control Module.

30) Use of an attachable Laser Rangefinder on a common Control Module.

31) Use of an attachable Chemical Detection and Analysis Module on a common Control Module.

32) Use of an attachable Radiation Detection and Analysis Module on a common Control Module.

33) Use of a Thermonic cooler to cool a focal plane array FLIR—approximate temperature 77° K.

Thermonic cooler from Eneco, Inc. or equivalent

Focal Plane Array from DRS Technologies or equivalent

Packaging that will encompass the Thermonic Cooler and Focal Plane

Array such that the cryogenic temperatures can be maintained with minimal thermal loss and energy consumption.

34) Storage of sensor setting parameters in non-volatile memory in the sensor module (gain, integration, contrast, and the like)

35) Dynamic Menus in Control Module changes with sensor that is attached.

36) Downloading of Control Module code or commands, or part of the code or commands from the Sensor to the Control Module. This provides a “universal” control module that can support sensors developed after the Control Module, or upgrades to sensors developed after the control module.

37) Use of an http browser in the Control Module.

38) Use or “mini-servers” to serve the user interface and application for the sensor.

39) Use of IP as an interface between the control module and the sensor.

40) Use of IP as an interface between the control module and other devices.

41) Use of a “mini-server” in the Control Module to serve data to workstations or other devices from the sensor to the other devices.

Another important aspect of the invention is the method of combining one or more basic user controls to perform optimized adjustments of multiple gain elements in the various components, particularly the night vision system. This can be applied to the Image Intensifier module, the uncooled FLIR module, or to the cooled FLIR module in a similar fashion. There are a multitude of programmable gain elements in the complex system that can adjust gain. In many cases, increasing the gain of an element will increase the noise from that element. A notable exception might be an iris. However increasing the gain of an image intensifier tube to the maximum will likely cause the noise of the tube to increase. Unfortunately, if an image intensifier tube is run such that its gain is low, it is photon starved, the output would be low. Thus, to get an image through the system the gain of the camera may be increased substantially and this will generate noise. The key is to balance all of the mechanical, electro-optical and electronic elements such that each element of the system is running at an optimum gain for the incoming light level, and that each element is feeding the next element at an optimum level.

FIG. 6 shows the a graphic of the relationship of the elements of an image intensifier module for the base unit. The left vertical axis, as drawn, is light intensity. The horizontal axis is gain. Starting on the left, we show a scene to be imaged. The lens contains a motorized iris that can be utilized to mechanically control the amount of light that is projected on the input side of the image intensifier tube. The iris ideally is at stepped down to various partial open positions under under bright conditions and opened up under low light conditions, thus providing a more uniform illumination level to the intensifier tube under varying light levels.

The image intensifier is a gated type of tube with and external gain input control. This control in prior art systems is a simple variable resistor that is adjusted by the user while viewing the output of the tube. In the system of the preferred embodiment it is controlled by a circuit element that is interfaced to the control processor 86 of the base unit (see FIG. 5). Therefore, the gain of the tube can be adjusted under computer control. The relay lens then images the light coming from the output side of the image intensifier to a solid state camera such as, by way of example, a CMOS camera or CCD camera. The camera has a gross light level adjustment that is called the shutter. This is an electronic mechanism that gates the active area of the CMOS or CCD sensor for a specific amount of time, thus letting photons discharge wells or electrically controlled gates in the solid state array. The longer the time that is metered to the imager chip for exposure, such as 1/30 of a second, the more sensitive the imager will be to the light. The shorter time that the light is metered to the chip, such as 1/2000 or 1/10000 of a second, the less sensitive that the camera will be to the light, thus controlling the camera gain.

The camera also has highly sensitive analog preamplifiers that take the measured photon signal and amplify the electronic signals resulting from the photon interaction with the semiconductor. The gain of this amplifier can be controlled in the analog domain under digital control from the processor.

Various filters can be programmed in and out based upon various modes of operation. For example, if the tube is being operated at a higher gain, it may produce noise that can be filtered in the analog domain. This function can just as easily be implemented in the digital domain by, for example, a high speed DSP, but the filter element would then be located after that A/D converter. Finally, look-up tables can be utilized to process incoming video signals to enhance contrast, brightness or provide other non-linear adjustments such as gamma.

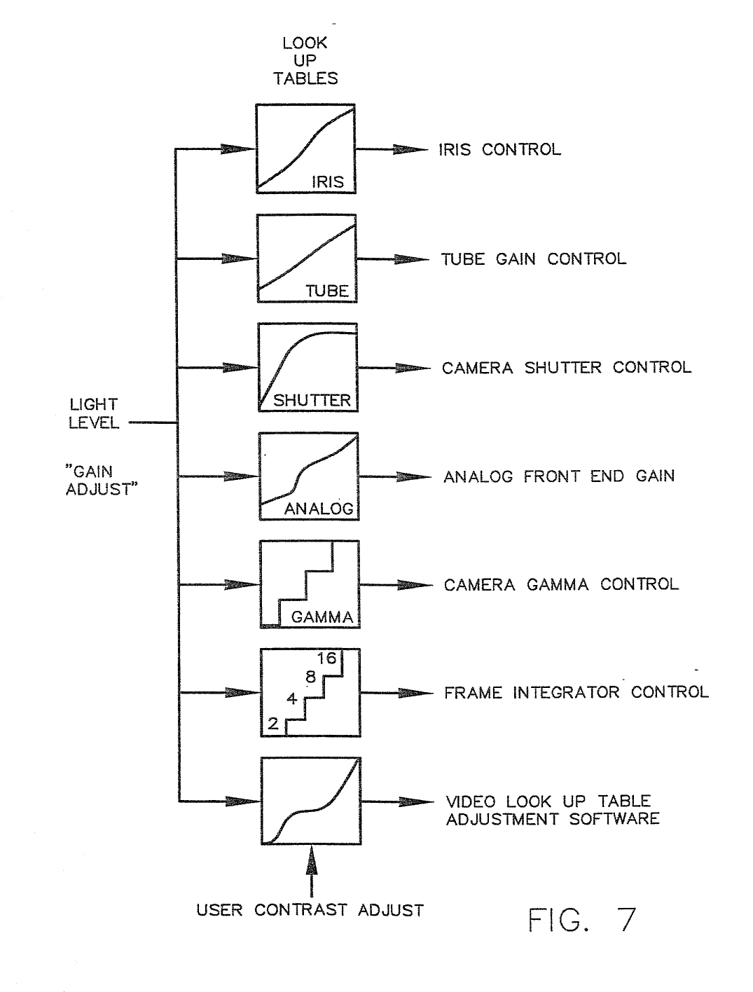

All of these adjustments can be provided in sequence, such as is illustrated by FIG. 7. In this case the elements would be operated at a nominal low gain position when a high level of light is provided. As the light level decreases the gain of each stage is brought up to maintain image brightness and contrast at the output of the sensor system. As each stage has the gain increased, a corresponding noise increase will likely be seen. Stage-by-stage, each is turned up until maximum gain is achieved. Individual gains may be adjusted in a linear or non-linear fashion. Linear adjustment is shown for simplification. The individual elements can be adjusted in either linear or non-linear manners, and can be calculated by mathematical functions in software or by look-up-tables.

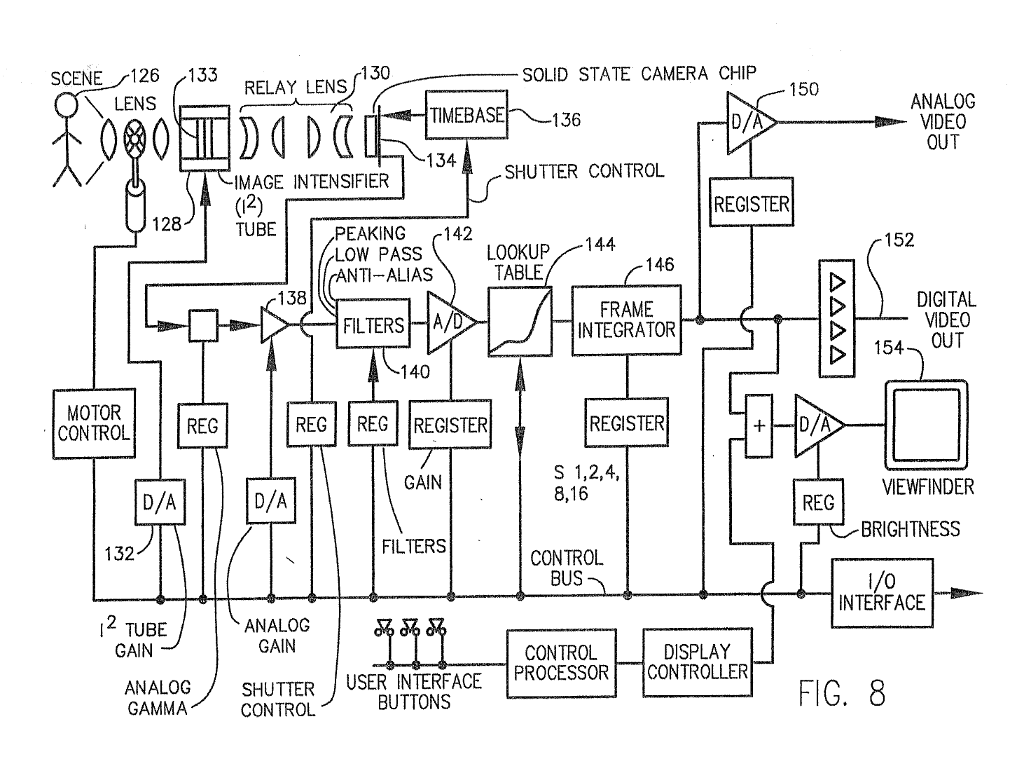

FIG. 8 illustrates a more flexible method wherein all programmable elements of the system may be adjusted in any desired manner for each step in gain setting. In this method, one or more of the programmable elements can be adjusted for each and every step increase in gain. The individual elements can be adjusted in an either linear or non-linear manner, and can be calculated by mathematical functions in software or by look-up-tables. With specific reference to FIG. 8, the scene is shown as the individual designated by the reference numeral 126. This is picked up by the image intensifier tube 128 and directed through the lens assembly 130. The intensifier tube includes an irised lens 133 controlled by the gain module 132. The lens assembly 130 is focused on the solid state camera chip 134. A timebase module 136 controls the shutter speed. The image output from the camera chip is introduced into an analog camera 138 from there to a filter system 140. It is then converted to a digital signal at convertor 142 and modified by the look-up tables 144, afterwhich it is introduced into the fame integrator 146. The output of the frame integrator is distributed to an analog output line through the convertor 148, a digital line out 152, and various other components such as the viewfinder 154.

One of the primary functions of the Common Control Module is the video frame averaging to remove video noise generated by the camera and video amplifiers used in the image intensifier, uncooled FLIR and cooled FLIR units. In the Intensifier, noise is also generated by the image intensifer tube, which is removed in addition.

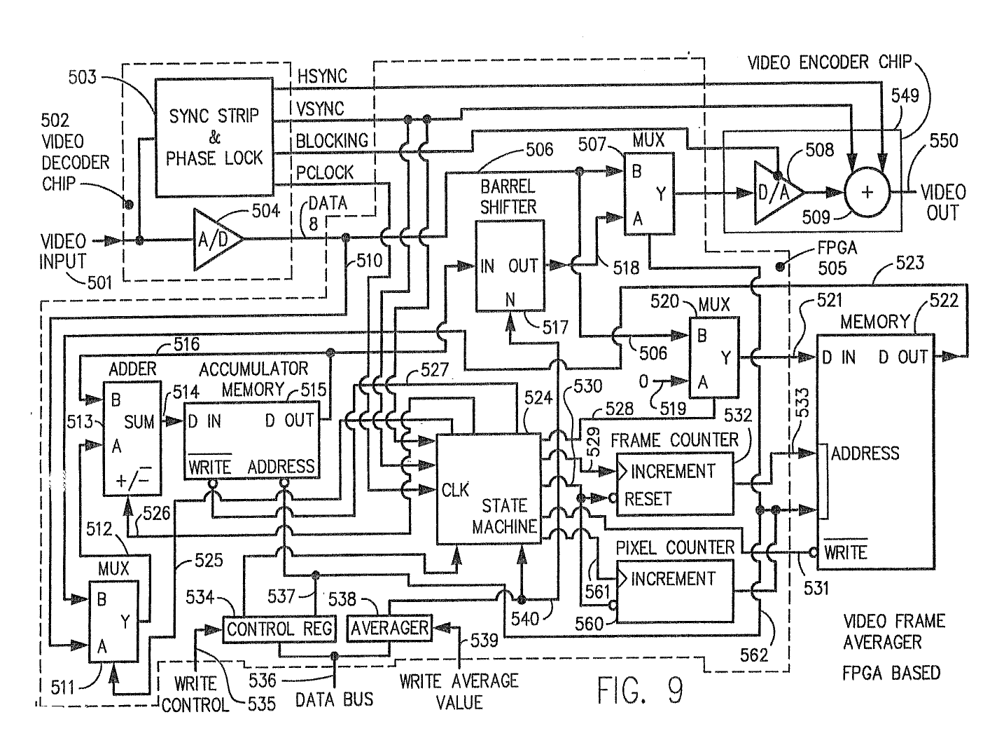

A detailed diagram of the video frame averager is shown in FIG. 9. A primary design goal of the video frame average is low power and small size. To accomplish this the frame average design is based around a single FPGA and a dynamic memory operated in conjunction with a low power video A/D and D/A. The averaging function can also be implemented with a high speed digital signal processor (DSP), however the power consumption, size, weight and cost would be greater and would impact the user.

The frame averager implementation in the preferred embodiment has two modes: 1) video bypass that allows viewing of “raw” or unprocessed video, and 2) “frame averaging”, also called “frame integration”, that allows accurate mathematical integration of two, four, eight, or sixteen video frames. More frames could be integrated with the addition of memory, a larger counter, and a larger accumulator/barrel shifter. The frame averager of the preferred embodiment has enough memory to store all pixels from previous frames in the amount of the number of frames to be integrated. For example, if integration is desired for 16 frames of 720 pixels by 440 pixels, sufficient memory is provided to store the raw data for 16 frames of 316,800 pixels. This is utilized to calculate the average on a basis that is updated on a real-time frame rate, such as 30 frames per second.

The basic video averaging algorithm used consists of the following primary steps:

Initialize

Zeroize all Memory Locations

Clear Frame Address Counter

Clear Pixel Address Counter

Clear Accumulator

Next Pixel

Select Zero

Story in Memory

Increment Pixel Counter, Check for Last Pixel Location

If No, Go to Next Pixel

Increment Frame Counter, Check for Last Frame

If No, go to Next Pixel

Reset Frame Counter

Go to Next Pixel

Average

Barrel Shift Accumulator

Output Average Pixel Value

Read Oldest Pixel Value at Pointer

Subtract from Accumulator

Input Next Pixel Value

Add to Accumulator

Increment Pixel Counter, Check for Last Pixel

If No, go to Average

Increment Frame Counter, Check for Last Frame

If No, go to Average

Reset Frame Counter

Go to Average

FIG. 9 is a depiction of the operation of the hardware and state machine implemented in the preferred embodiment in the base control module. Video from the sensor element is presented on input 501 to the video decoder chip 502. The decoder chip separates out the timing signals such as horizontal sync, vertical sync, blanking, and a pixel clock utilizing sync stripping and phase lock loop circuits in a well known manner. It also contains an analog-to-digital converter 504 to convert the analog video input to a digital signal for processing. It is also evident that a digital signal can be directly input to the system by bypassing the video decoder chip 502.

The frame averager incorporates bypass mode whereby the incoming video can be routed to the output without averaging. This is accomplished by setting a bypass command into control register 535 utilizing data bus 536 and write strobe 535. This sets the signal on wire 573 to allow unprocessed video data 506 to be selected by multiplexer 507 input B to be presented to the D/A converter on the video encoder chip 509 to produce the unprocessed video at video output 550.

The frame averager is set into the video averaging mode by setting the control register 534 to average by presenting a command on the data bus 536 with a strobe on 535, and by setting the number of frames to be averaged by setting the register 538 by presenting a value on bus 536 with a strobe on 539. This value is utilized to determine the divisor being done in the barrel shifter 517. This also determines the number of memory positions utilized in memory 522 by setting the range of the fame counter 532.

The frame average is first initialized by zeroing memory 522. The state machine 524 first selects input A on multiplexer 520, which is a zero value This presents data of zero value to the din on memory 522. The frame counter 532 and pixel vounter 560 are reset by a pulse on 530. The memory then is written with a strobe on “Write” via wire 531, then them pixel address is incremented to the next location with a pulse on 561. The process of writing is repeated until the appropriate number of memory locations for one full frame have been zeroed. Then the frame counter 532 is incremented by a pulse on 529, and the above process of writing all pixels in a frame is repeated. This continues until all frames as is specified by register 538 have been zeroed. This leaves all necessary memory locations set at zero. The accumulator 513 is reset by signal 530 from the state machine. The state machine 524 can then exit the initialization process.

Note that the above initialization process can be skipped and the memory with an appropriate number of cycles will self initialize. This, however, can result in a “glitch” in the video each time that the video averager is activated on, which may be objectionable. Use of the initialization process will gracefully start up the integrator.

Another method to initialize the integrator without generating a video “glitch” is by holding off the switching of the multiplexer 507 from B, live video, to A, averaged video, until after the integrator is fully initialized by processing the full number of pixels for a total number of fields specified by the Average register 538 before switching the multiplexer 507 from the B input to the A input. This masks the average stabilizing by presenting live video until the averager has process one completed sequence of frames and thus is holding one complete set of historical data in memory.

After initialization, the video averager can be fully activated. The multiplexer 507 is set for the A input which allows averaged video to pass to the video output 550 via the video encoder 549. Multiplexer 520 is set for the B input which allows video pixel data to be written to the memory 522.

Multiplexer 511 is set to the A input by state machine 524. New pixel data on bus 506 is selected to go to the adder 513, which also may be called the accumulator. The barrel shifter 517 is set to divide by the integer amount specified in register 538 by doing a binary shift by the appropriate number of bit for division: 1 bit for averaging 2 frames, 2 bits for 4 frames, 3 bits for 8 frames, 4 bits for 16 frames, and so on in a binary power progression. Multiplexer 520 is set to input B during averaging operation to allow the actual video pixel value to be stored in memory by the control signal 528.

The above having been set, the averaging process then follows the repetitive processes. Memory Chip 515 contains the averaged field at any one time. There is a value for each pixel of the field stored in the memory, and in the preferred embodiment it is of higher precision than the incoming video as it has not been divided until it is processed by the barrel shifter 517.

A historical copy of all of the pixel date from the last N frames that have been averaged is stored in memory 522. The sum for each pixel in memory 515 is updated by selecting the raw pixel data for the oldest frame in the memory, subtracting it from the previous sum in acumulator memory 515 then adding in new pixel data form bus 510. This is accomplished by setting the multiplexer 511 to input B by using signal 525, setting the adder 513 to subtract by using signal 526, then capturing the result by clocking memory 515 with a clock on 527. The multiplexer 511 is then set to input A allowing the newest incoming pixel data 510 to be summed into the average by setting the adder 513 to add utilizing wire 514, then clocking the memory 515 to capture the new sum. This sum is then barrel shifted using barrel shifter 517 to do the divide, and presented to the video encoder via bus 518 and multiplexer 507. The averaged video data is then available on video output 550. This process is repeated for each pixel in the frame, with the pixel counter 560 being incremented by the state machine 524 for each pixel clock. After the average has been processed for one frame, the state machine increments the frame counter 532 via signal 529, or resets it via signal 530 if the total number of frames to be integrated has been met.

It can be seen that the accumulator memory 515 can be implemented within in memory 522 to conserve hardware, but the accuracy of the accumulator is grater than the historical data so the memory either has to be made wider in word width, or two memory cycles are required. In addition moving the accumulator into the memory 522 places an additional bandwidth burden on the memory, thus causing it to have to be an extremely expensive fast part and causing it to consume more power. In the preferred embodiment it was found that maintaining separate memory for the accumulator and the historical memory is preferable.

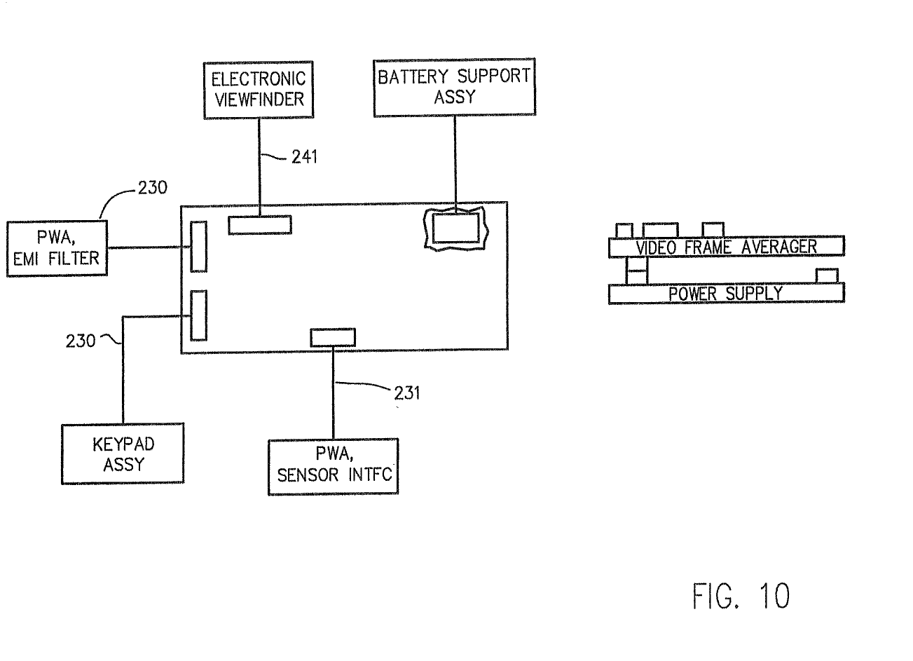

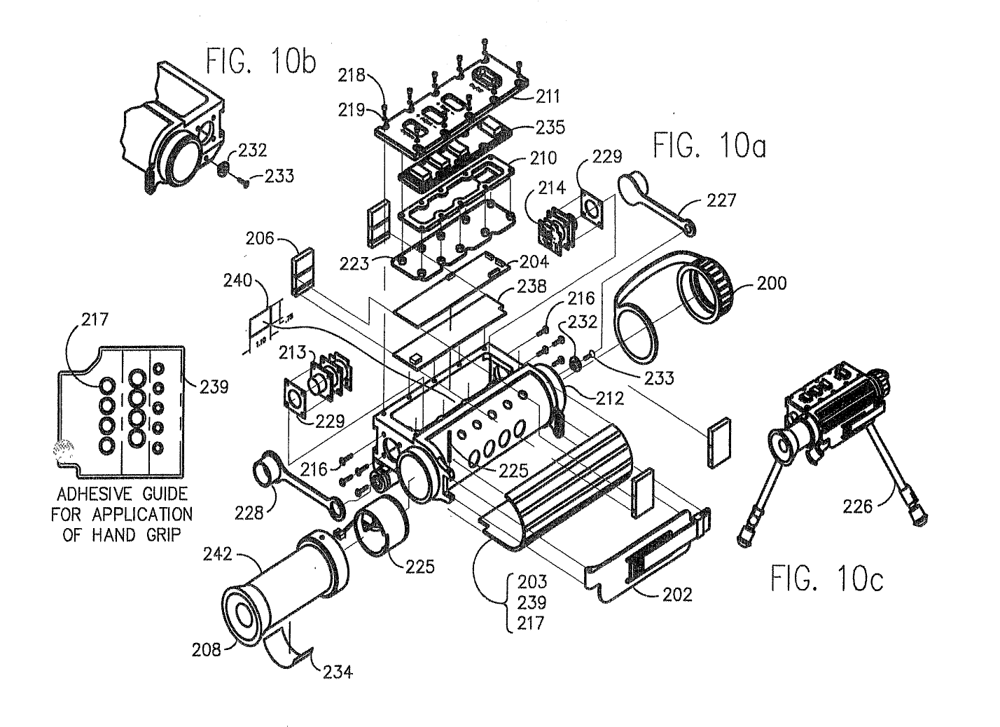

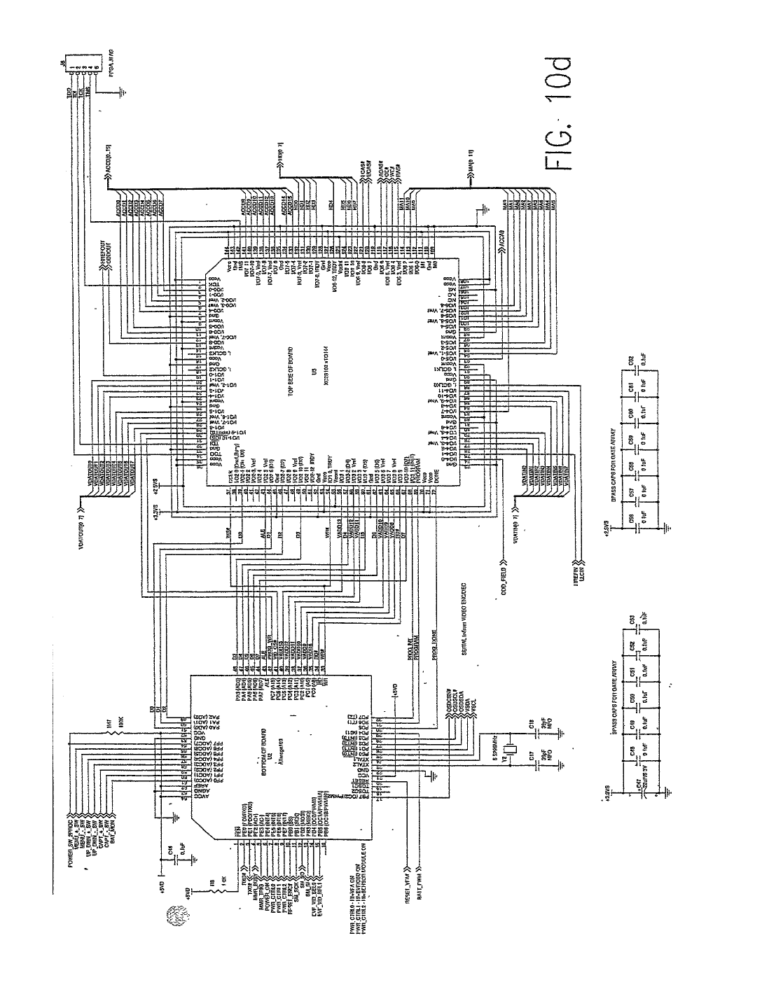

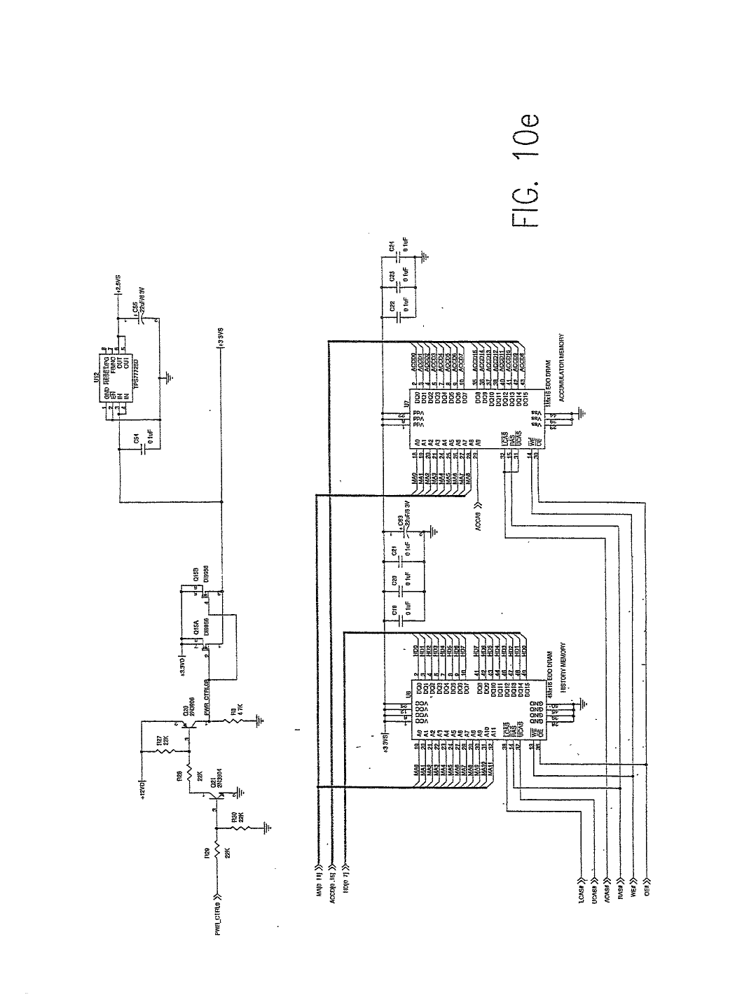

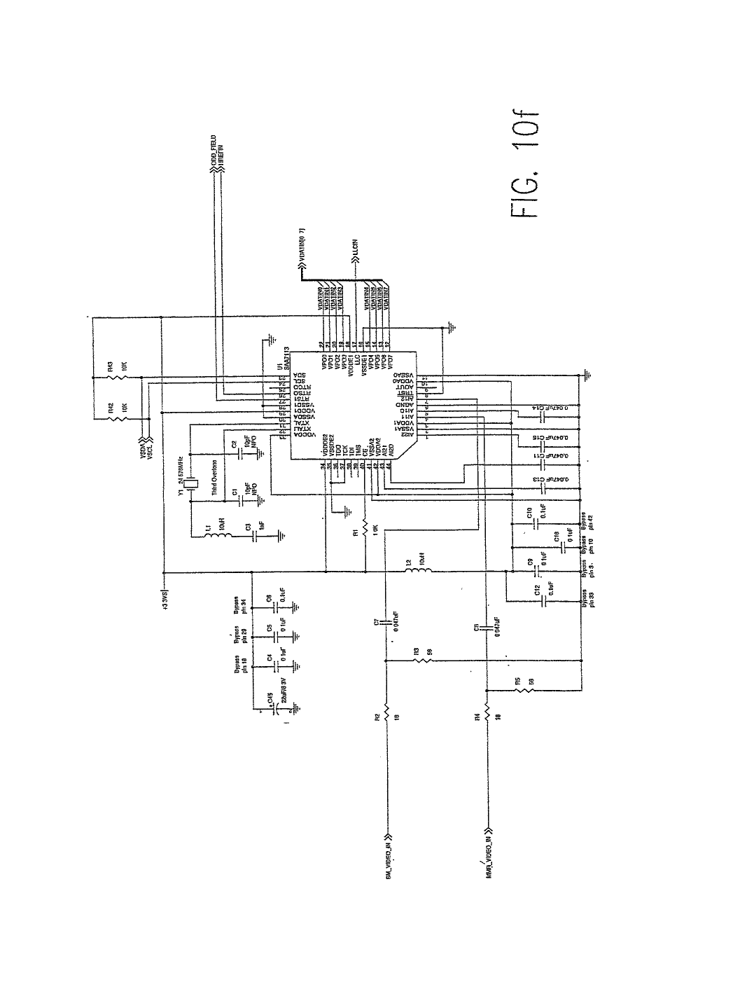

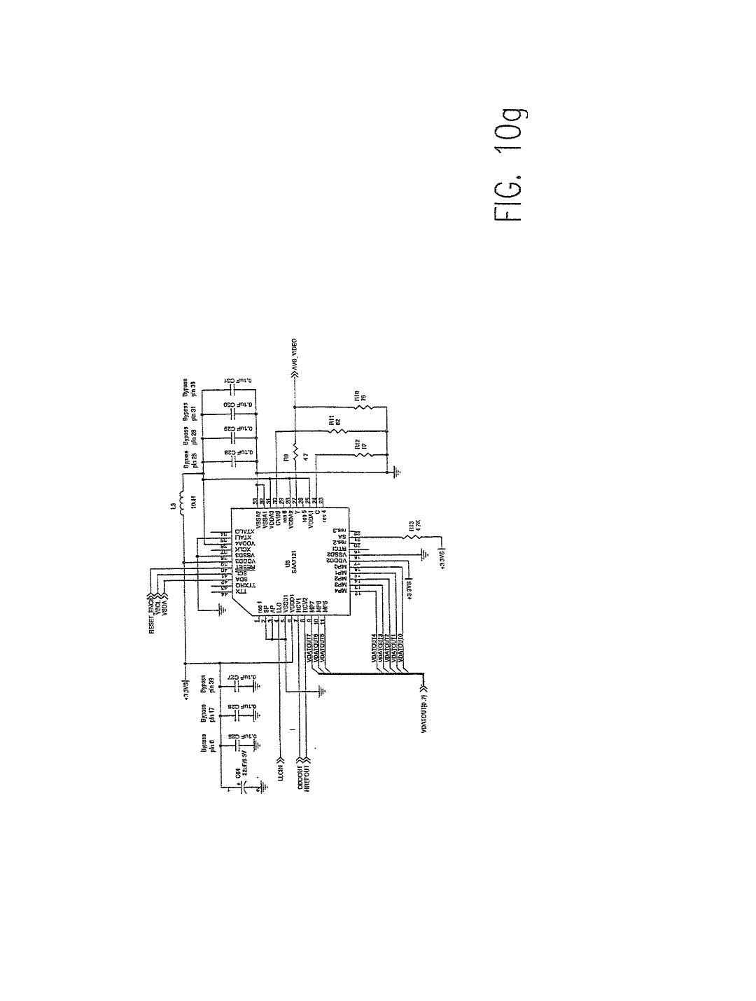

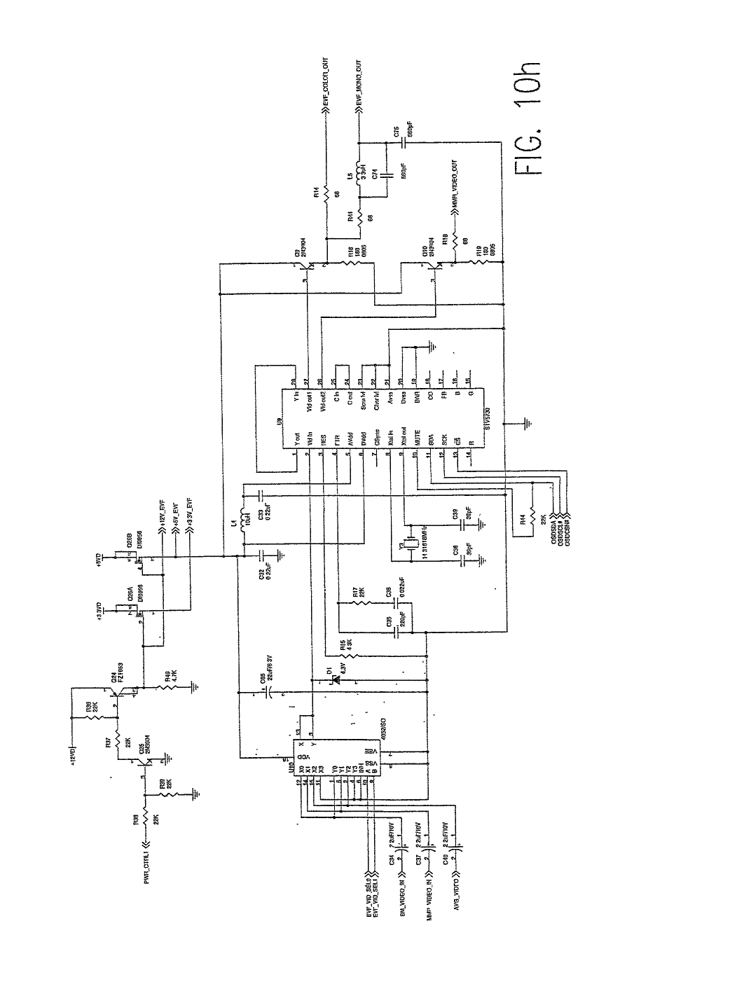

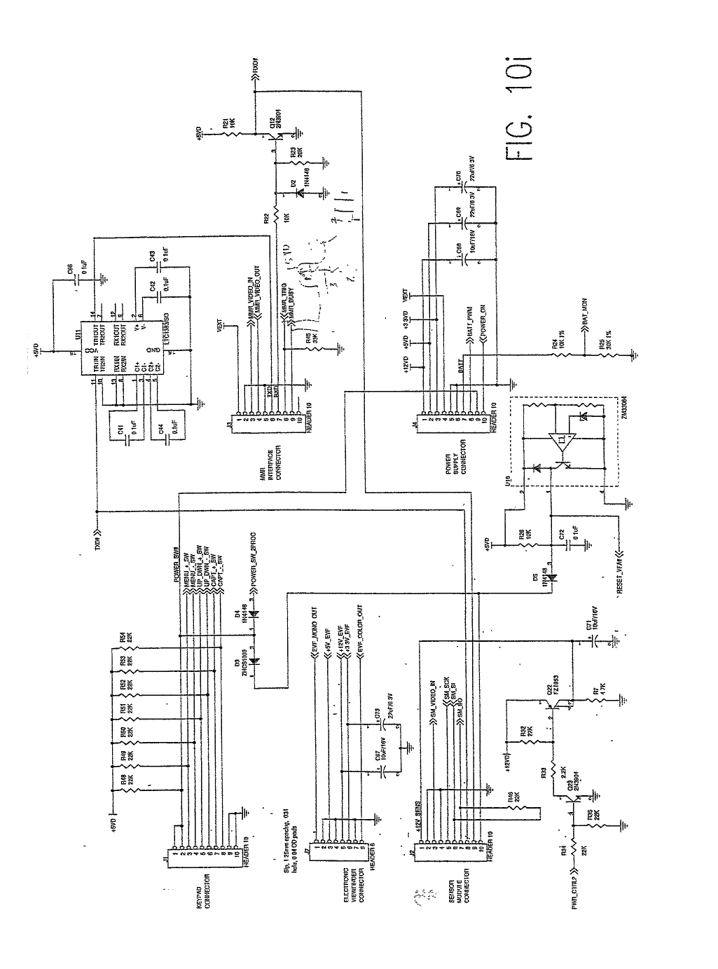

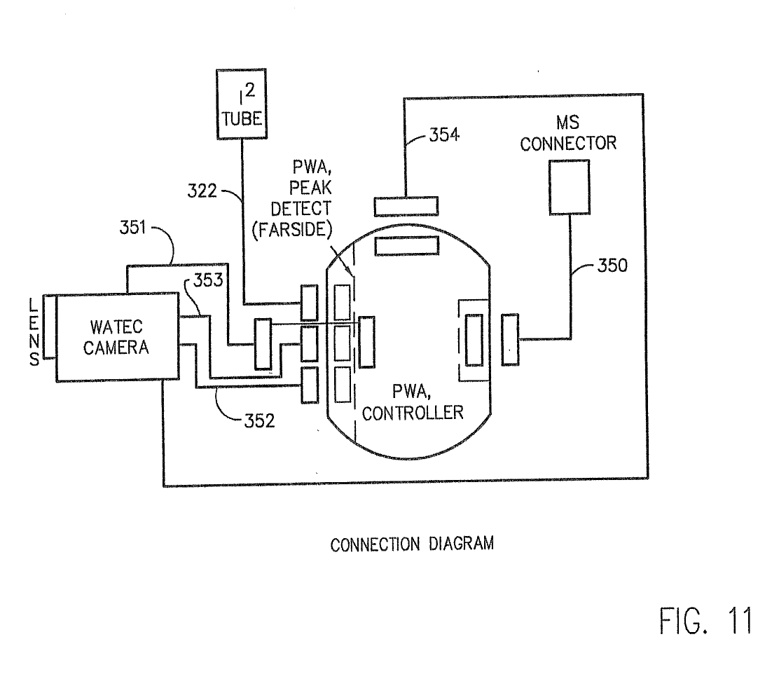

FIGS. 10 and 10a-10i are detail drawings of the base module shown in FIG. 1. FIG. 10 is a block diagram showing the major components and their interconnectivity. Specifically, the base module includes a base unit coupled to a battery support assembly, an electronic view finder, a PWA EMI filter, and input or keypad assembly for controls and a PWA sensor interface. In addition a power supply assembly and a video frame averager is provided. The specific mechanical components of the assembly are shown in the exploded view of FIGS. 10a and 10b and assembly of FIG. 10c. The assembly is self explanatory from the drawing. For references purposes, the components are numbered as follows:

201 top assembly of the control module;

202 hand strap

203 handgrip

204 O ring

205 battery support

206 support

207 not used

208 eyecup

209 not used

210 retainer for keypad module

211 top cover

212 housing weldment

213 PWA sensor interface

214 PWA EMI filter

215 not used

216 pan screw

217 silicone sealant

218 screw

219 washer

220 batter cap assembly

221 not used

222 not used

223 elastic lock nut

224 not used

225 dowel pin

226 support leg

227 battery interface module cap

228 battery sensor cap

229 gasket

230 ribbon

231 cable

232 retainer cap

233 flat head screw

234 serial number plate

235 keypad

236 locking ring

237 video frame processor and control board

238 power supply control board

239 adhesive

240 tape

241 viewfinder cable assembly

The control circuitry is shown in FIGS. 10d-10i. All of the pin numbers are those of the manufacturer.

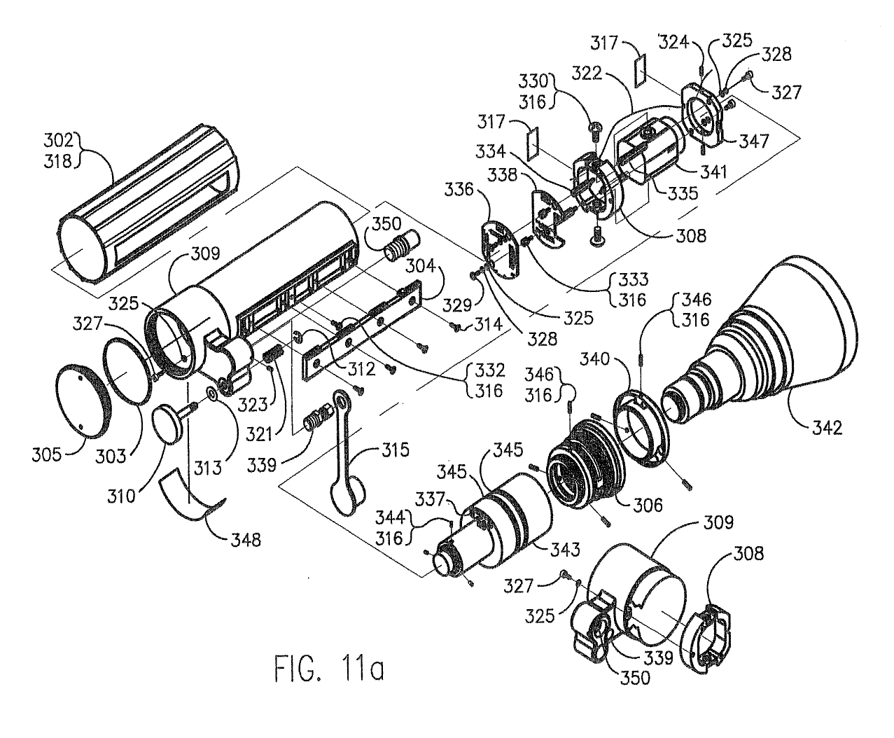

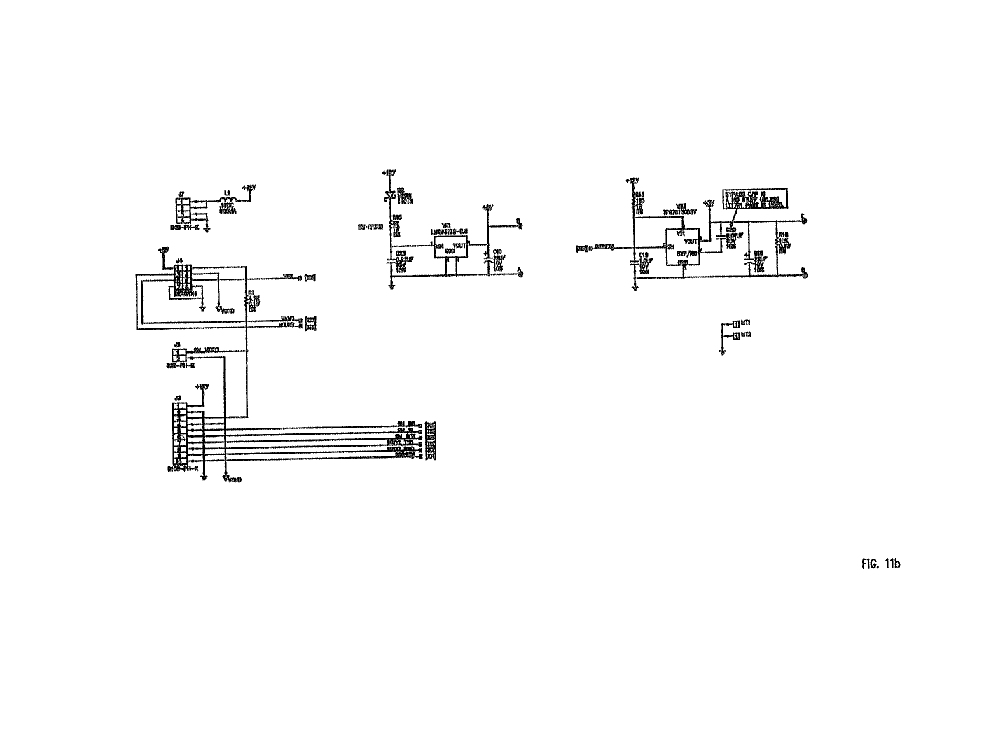

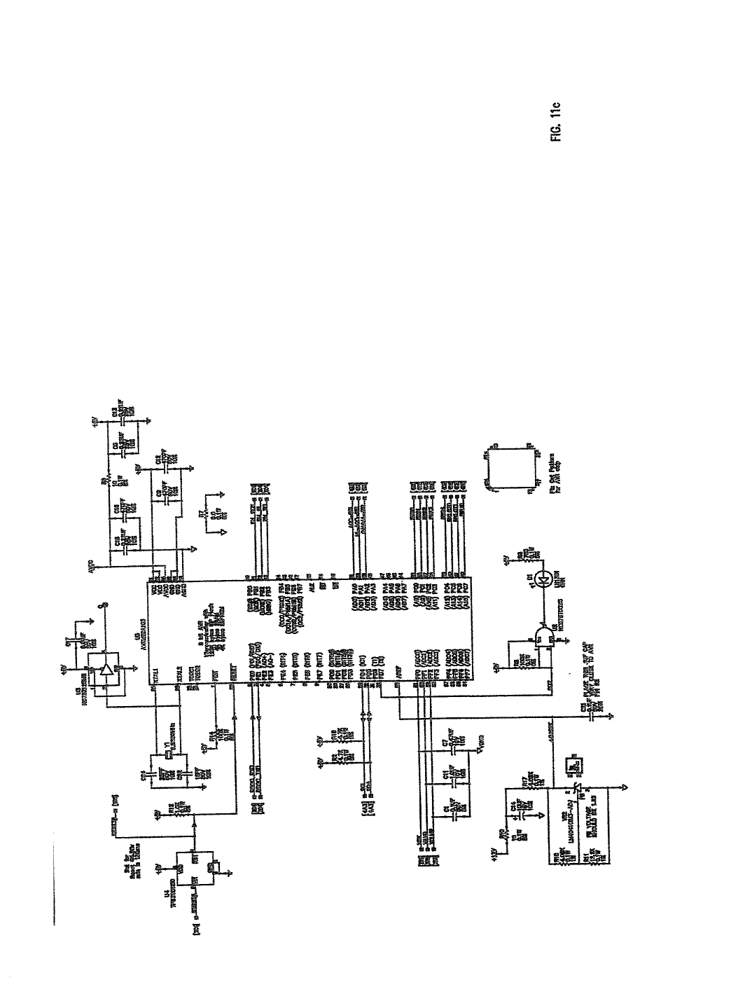

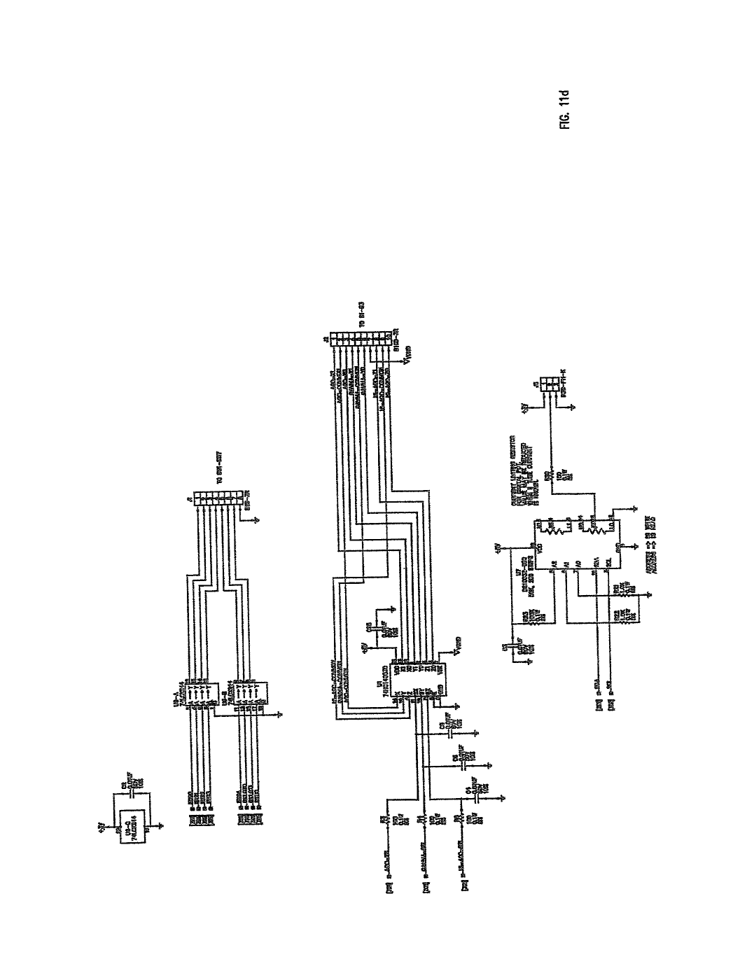

FIGS. 11 and 11a-11d are detail drawings of the night vision module shown in FIG. 1. FIG. 11 is a block diagram showing the major components and their interconnectivity. Specifically, the night vision module includes a base unit having a controller with an MS connector, an I2 tube and a commercial camera and lens assembly. The MS connector connects the module to the base locked in the receiving slide and rail system previously described. The specific mechanical components of the assembly are shown in the exploded view of FIG. 11a. The assembly is self explanatory from the drawing. For references purposes, the components are numbered as follows:

301 top assembly

302 hand grip

303 O ring

304 slide

305 rear end cap

306 front end cap

307 not used

308 camera support

309 weldment

310 jackscrew retainer

311 not used

312 ring

313 washer

314 flat head screw

315 connector cap

316 sealant

317 tape

318 adhesive

319 not used

320 not used

321 compression spring

322 I2 tube assembly with relay lens, camera and interface board

323 locking screw

324 locking screw

325 washer

326 not used

327 Allen screw

328 splitlock washer

329 screw

330 pan head screw

331 not used

332 pan head screw

333 standoff

334 standoff

335 standoff

336 PWA controller

337 PWA contact

338 PWA peak detector

339 Schrader valve

340 Ring stopper

341 CCD camera assembly

342 objective lens

343 relay lens

344 set screw

345 O ring

346 set screw

347 relay lens support

348 serial no. plate

349 not used

350 control cable assembly.

The night vision circuitry is shown in FIGS. 11b-11d. All of the pin numbers are those of the manufacturer.

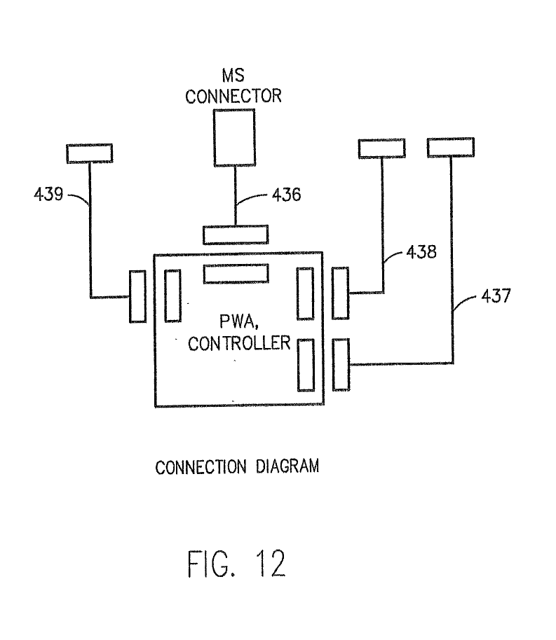

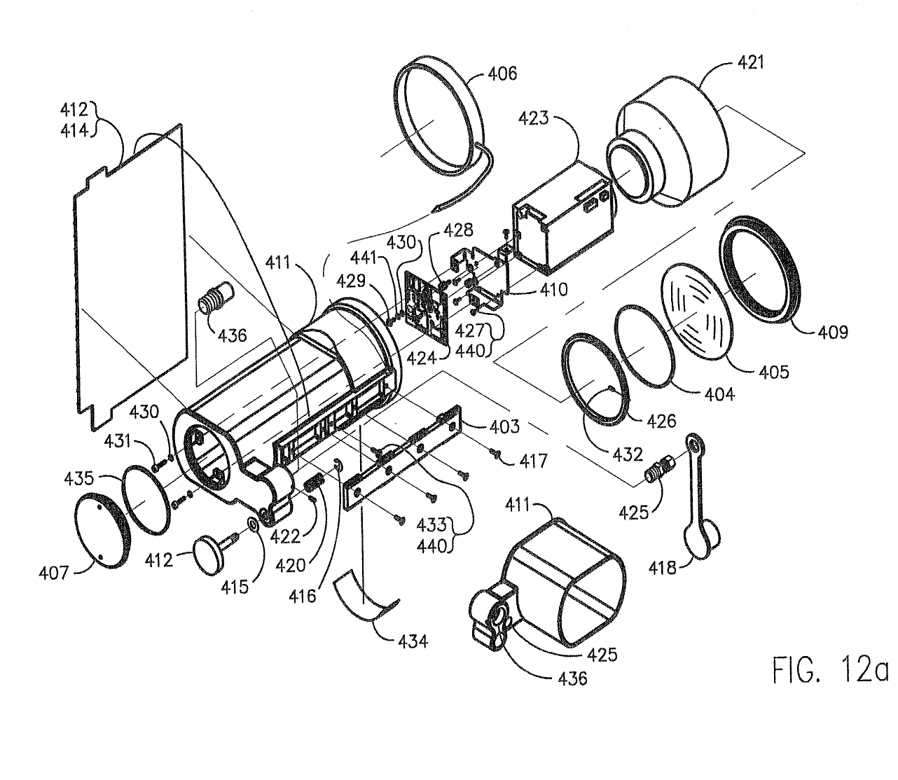

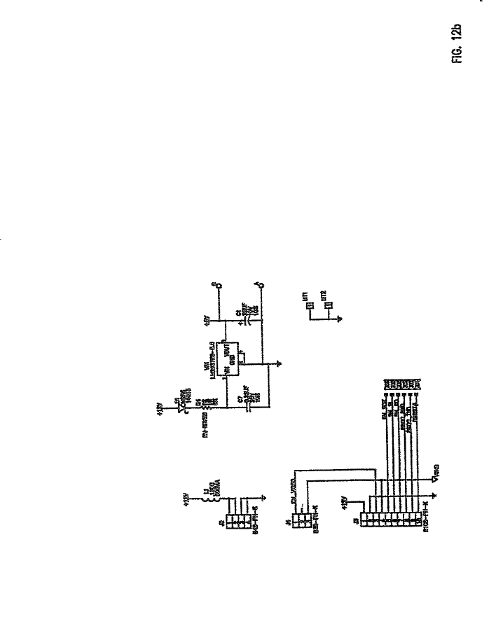

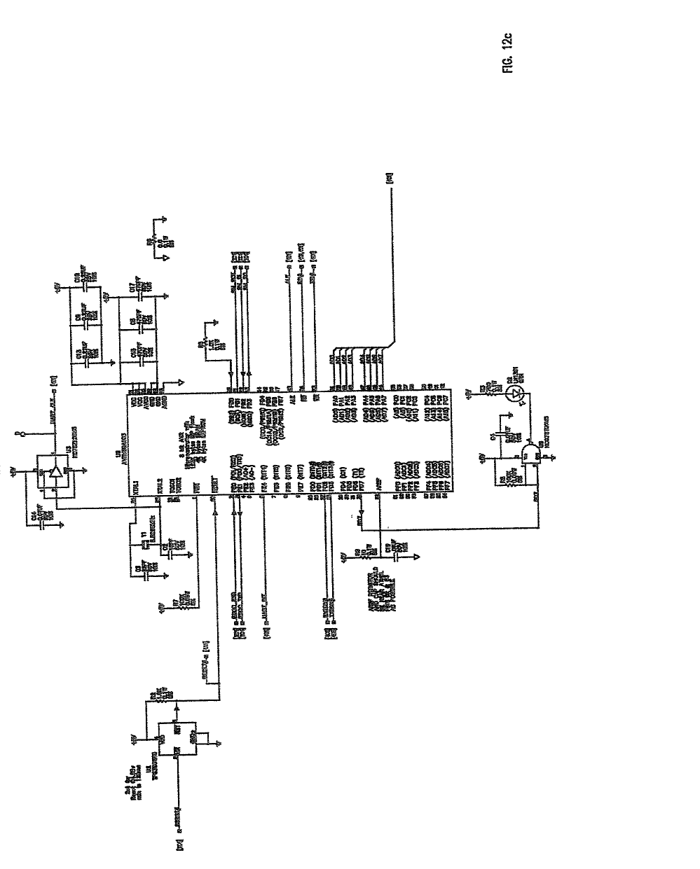

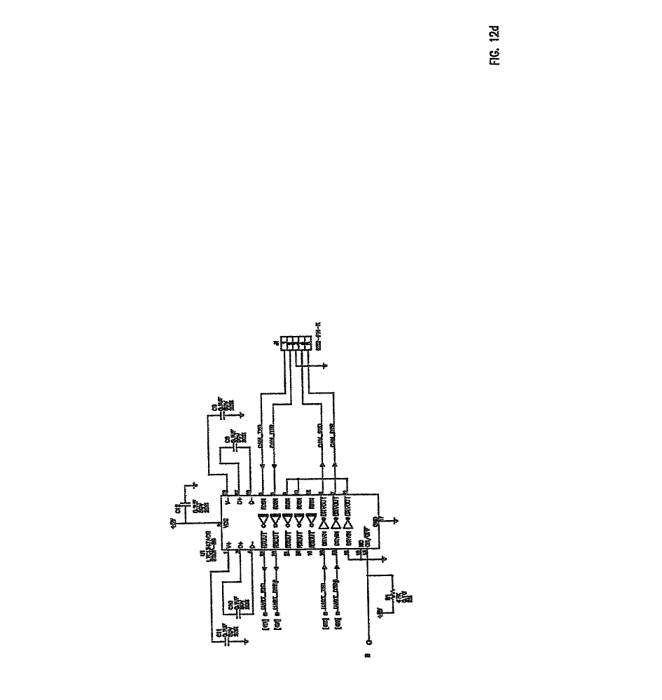

FIGS. 12 and 12a-12e are detail drawings of the day vision module shown in FIG. 1. FIG. 12 is a block diagram showing the major components and their interconnectivity. Specifically, the day vision module includes a base unit having a controller with an MS connector, and a commercial camera and lens assembly. The MS connector connects the module to the base when locked in the receiving slide and rail system previously described. The specific mechanical components of the assembly are shown in the exploded view of FIG. 12a. The assembly is self explanatory from the drawing. For references purposes, the components are numbered as follows:

401 top assembly

402 hand grip

403 slide

404 O ring

405 lens

406 lens cap

407 end cap

408 not used

409 retainer

410 support

411 weldment

412 jackscrew

413 not used

414 adhesive

415 washer

416 ring

417 flat head screw

418 connector cap

419 not used

420 compression spring

421 lens

422 self-locking screw

423 camera

424 PWA controller

425 Schrader valve

426 retainer

427 pan head screw

428 standoff

429 screw

430 washer

431 Allen screw

432 set screw

433 pan screw

434 serial number plate

435 O ring

436 interface cable assembly

437 video control cable assembly

438 power cable assembly

439 communications cable assembly

440 sealant

441 splitlock washer

The day vision circuitry is shown in FIGS. 12b-12e. All of the pin numbers are those of the manufacturer.

While certain features and embodiments of the invention have been described in detail herein, it will be readily apparent that the invention includes all modifications and enhancements within the scope and spirit of the following claims.

1. A modular, multi-functional, hand-held surveillance system comprising:
a. A base unit having a receiving assembly;
b. A component unit having a mounting assembly, wherein the receiving assembly in the base is adapted for accepting the mounting assembly for securing the component unit to the base;
c. An electrical interface in the base;
d. An electrical interface in the component unit and adapted for engaging the electrical interface in the base when the base and component unit are in mounted assembly;
e. A power supply in the base and adapted for communicating with the component unit through the base and component unit interfaces when the base and component unit are in mounted assembly;
f. A control system in the base and adapted for communicating with the component unit through the base and component unit interfaces when the base and component unit are in mounted assembly;
g. A locking system for locking the base and the component unit in mounted assembly.

2. The system of claim 1, wherein the receiving assembly comprises a channel slide mounted on the base and wherein the mounting assembly comprises a rail system mounted on the component unit and mated with the channel slide, whereby the component unit is adapted for sliding into the channel slide.

3. The system of claim 2, wherein the electrical interfaces comprise a plug and receptacle combination mounted on the base and the component unit in a manner adapted for sliding engagement and contact when the component unit is slidingly mounted on the base.

4. The system of claim 2, wherein the locking system includes interlocking components in the base and the component unit adapted for engaging when the component unit is slidingly mounted on the base.

5. The system of claim 1, wherein the component unit further comprises a night vision camera.

6. The system of claim 1, wherein the component unit further comprises a day vision camera.

7. The system of claim 1, wherein the component unit further comprises a laser range finder.

8. The system of claim 1, wherein the component unit further comprises an RF probe.

9. The system of claim 1, wherein the component unit further comprises an NBC detector.

10. The system of claim 1, wherein the component unit further comprises a FLIR system.

11. The system of claim 10, wherein the FLIR unit is an uncooled FLIR.

12. The system of claim 10, wherein the FLIR unit is a cooled FLIR.

13. The system of claim 12 wherein the FLIR unit is cooled by a solid state thermonic device.

14. The system of claim 1, wherein the base module is a military sensor computer.

15. The system of claim 14, further including connector interfaces for connecting cables to the base for external communication devices.

16. The system of claim 1, wherein the base module is an MMR unit.

17. The system of claim 16, further including connector interfaces for connecting cables to the base for external communication devices.

18. The system of claim 1, wherein the base further includes connector interfaces for connecting cables to the base for external communication devices.

19. The system of claim 18, wherein the communication devices include a breakout box.

20. The system of claim 17, wherein the communication devices include a communications link.

21. The system of claim 1, wherein the electrical interface in the base is adapted for cable connecting external devices to the base.

22. The system of claim 1, wherein the control circuit is adapted for shared use of image processing hardware and software for noise reduction for multiple component units.

23. The system of claim 1, wherein the control circuit is adapted for the shared use of image processing hardware and software for contrast enhancement for multiple component units.

24. The system of claim 1, wherein the control circuit is adapted for the shared use of Motion Detection and Alarm hardware and software for multiple component units.

25. The system of claim 1, wherein the control circuit is adapted for the shared use of image stabilization hardware and software for multiple component units.

26. The system of claim 1, wherein the control circuit is adapted for the shared use of contrast enhancement hardware and software for multiple component units.

27. The system of claim 1, wherein the control circuit is adapted for the shared use of image cropping hardware and software for multiple component units.

28. The system of claim 1, wherein the control circuit is adapted for the shared use of image processing filtering functions for multiple component units.

29. The system of claim 1, wherein the control circuit is adapted for the shared use of image compression hardware and software for multiple component units.

30. The system of claim 1, wherein the control circuit is adapted for the shared use of communications protocols, hardware and software for multiple component units.

31. The system of claim 1, wherein the control circuit is adapted for the shared use of digital storage hardware and software for multiple component units.

32. The system of claim 1, wherein the control circuit is adapted for the shared use of geolocation hardware and software for multiple component units.

33. The system of claim 1, wherein the control circuit is adapted for the shared use of power supply hardware and control software, and common battery types for multiple component units.

34. The system of claim 1, wherein the control circuit is adapted for the shared use of video processing hardware and associated software.

35. The system of claim 1, wherein the control circuit is adapted for the shared use of video zoom hardware and software for multiple component units.

36. The system of claim 1, wherein the control circuit is adapted for the shared use of an electronic viewing device for multiple component units.

37. The system of claim 1, wherein the control circuit is adapted for the shared use of user interface controls for multiple component units.

38. The system of claim 1, wherein the control circuit is adapted for the shared use of a handgrip for portable use of multiple component units.

39. The system of claim 1, where in the control circuit housing is adapted for the shared use of tripod for holding

40. The system of claim 1, wherein the control circuit is adapted for the shared use of electronic interface for sensor data to other systems for multiple component units.

41. The system of claim 1, wherein the control circuit is adapted for the shared use of mounting equipment for multiple component units.

42. The system of claim 1, wherein the control circuit is adapted for supplying a common mechanical and electrical method of attaching various sensors to a control module and for providing support and electrical interface.

43. The system of claim 1, wherein the control circuit is adapted for supplying a common user interface with similar commands for similar functions between multiple component units.

44. The system of claim 1, wherein the control circuit is adapted for the use of an attachable an attachable image intensifier module on the base.

45. The system of claim 1, wherein the control circuit is adapted for the use of an attachable radiation detection and analysis module on the base.

46. The system of claim 1, wherein the control circuit is adapted for the use of a thermonic cooler to cool a focal plane array FLIR.

47. The system of claim 1, wherein the control circuit is further includes a storage device for storage of sensor setting parameters in non-volatile memory in the sensor module.

48. The system of claim 1, wherein the control circuit further includes dynamic menus adapted for changing with the change of component units.

49. The system of claim 1, wherein the control circuit further includes the capability of downloading code and commands.

50. The system of claim 1 the control circuit further supporting the use of an http browser.

51. The system of claim 1, wherein each module includes and iris for collecting the image and an image intensifier tube, wherein the control circuit further includes an image intensifier module for electronically adjusting the gain based on balancing the image quality with the noise level in the system.

52. The image system of claim 51, wherein there is a plurality of modules and wherein the image intensifier module is compatible with each of the various modules.

53. The image system of claim 1, the component adapted for generating a stream of frames of video or images, and wherein the control circuit is adapted for processing raw video as generated.

54. The image system of claim 1, the component adapted for generating a stream of frames of video or images, and wherein the control circuit is adapted for averaging sequential frames for producing an enhanced image.

55. The image system of claim 1, wherein multiple frames are averaged.

56. The image system of claim 55, wherein up to sixteen sequential frames may be averaged.
